(19) United States
(12) Patent Application Publication
(10) Pub. No.: US 2013/0187893 A1
(43) Pub. Date: Jul. 25, 2013

(54) ENTERING A COMMAND

(71) Applicant: Robert Campbell, Sunnyvale, CA (US)

(72) Inventor: Robert Campbell, Sunnyvale, CA (US)

(73) Assignee: HEWLETT-PACKARD DEVELOPMENT COMPANY, Fort Collins, CO (US)

(21) Appl. No.: 13/877,380

(22) PCT Filed: Oct. 5, 2010
(86) PCT No.: PCT/US2010/051487

§ 371 Date: Apr. 2, 2013

(51) Int. Cl. G06F 3/042

(52) U.S. Cl. CPC G06F 3/042
USPC 345/175

(57) ABSTRACT

An embodiment provides for entering a command into a system. The method includes detecting a pattern placed in view of a sensor. The pattern can be recognized and associated with an operation code sequence. The operational code sequence may be executed when the sensor detects an intersection between the recognized pattern and an object.

### BACKGROUND

Early systems for entering commands into programs used keyboards to enter text strings that included the names of the commands, any input parameters, and any switches to modify operation of the commands. Over the last couple of decades, these systems have been nearly replaced by graphical input systems that use a pointing device to move an icon, such as a graphical representation of an arrow, to point at objects displayed on the screen and, then, select them for further operations. The selection may be performed, for example, by setting the icon over the object and clicking a button on the pointing device. In recent years, systems for entering commands have been developed that more strongly emulate physical reality, for example, allowing physical selection of items on a touch sensitive screen.

### BRIEF DESCRIPTION OF THE DRAWINGS

Certain exemplary embodiments are described in the following detailed description and in reference to the drawings, in which:

FIG. 1 is a drawing of a system, in accordance with an embodiment;

FIG. 2 is a block diagram of a system that may be used to implement an embodiment;

FIG. 3 is a drawing of a command template in accordance with an embodiment;

FIG. 4 is an example of a template in accordance with an embodiment;

FIG. 5 is a method for entering commands into a system, in accordance with an embodiment;

FIG. 6 is a method that may be used to enter commands to a system, in accordance with an embodiment; and

FIG. 7 is a non-transitory computer readable medium that may be used to hold code modules configured to direct a processor to enter commands, in accordance with some embodiments.

### DETAILED DESCRIPTION OF SPECIFIC EMBODIMENTS

Embodiments described herein provide an optical command entry system that can use an optical sensor system to enter commands selected from a template. The optical sensor system may be configured to monitor a three dimensional space in front of a monitor to determine locations of objects with respect to the display. A pattern recognition module can monitor an image of the area in front of the display as collected by the optical sensor system. If a template having printed patterns is placed in view of the sensor, the pattern recognition module may identify the patterns, map their locations, and associate them with particular commands, such as for an application. A command module may determine a location of an object, such as a finger, hand, or other object, in front of the display and, if the location of the object intersects one of the patterns, the command associated with that pattern can be passed to an application. In some embodiments, if one of the patterns is associated with a particular application, placing the template in front of the display may cause the pattern recognition module to start the associated application.

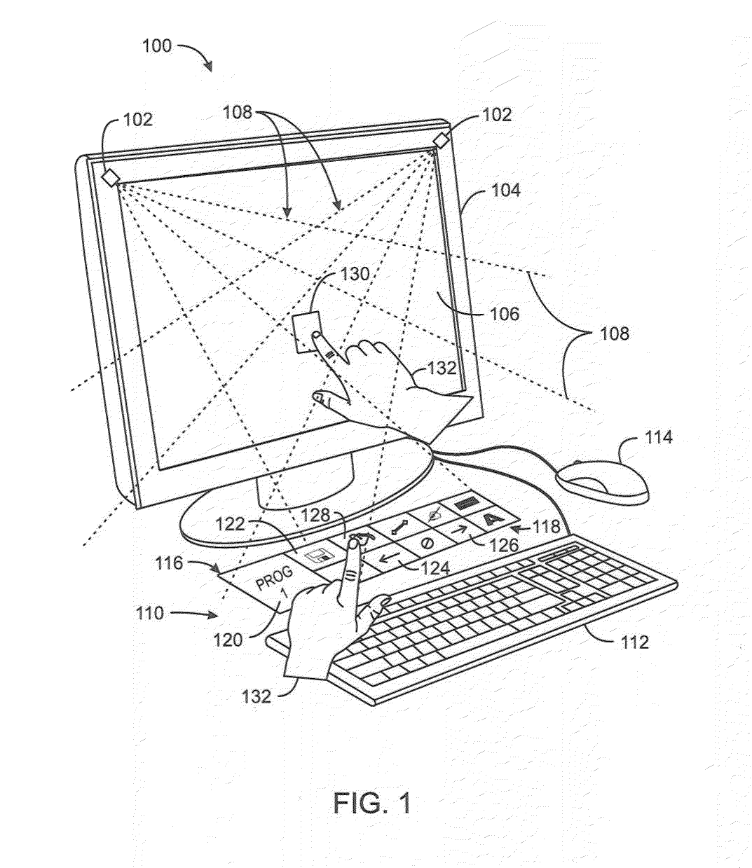

FIG. 1 is a drawing of a system 100, for example, an all-in-one computer system that can obtain control inputs from one or more sensors 102, in accordance with an embodiment. As used herein, an all-in-one computer system, is a computer that includes a display, processor, memory, drives, and other functional units in a single case. However, embodiments are not limited to the all-in-one computer system, as embodiments may include a stand-alone monitor comprising sensors, or a stand-alone monitor with separate sensors attached. The sensors 102 may be constructed into the case 104 of the system 100 or may be attached as separate units. In an embodiment, the sensors 102 can be positioned in each of the upper corners of a display 106. In this embodiment, each sensor 102 can cover an overlapping volume 108 of a three dimensional space in front of the display 106.

The sensors 102 may include motion sensors, infrared sensors, cameras, infrared cameras, or any other device capable of capturing an image. In an embodiment, the sensors 102 may include an infrared array or camera that senses the locations of targets using a time-of-flight calculation for each pixel in the infrared array. In this embodiment, an infrared emitter can emit pulses of infrared light, which are reflected from a target and returned to the infrared array. A computational system associated with the infrared array uses the time it takes for the infrared light to reach a target and be reflected back to the infrared sensor array to generate a distance map, indicating the distance from the sensor to the target for each pixel in the infrared sensor array. The infrared array can also generate a raw infrared image, in which the brightness of each pixel represents the infrared reflectivity of the target image at that pixel. However, embodiments are not limited to an infrared sensor array, as any number of other sensors that generate an image may be used in some embodiments.

The volume 108 imaged by the sensors 102 can extend beyond the display 106, for example, to a surface 110 which may be supporting the system 100, a keyboard 112, or a mouse 114. A template 116 may be placed on the surface 110 in front of the system 100 in view of the sensors 102. The system 100 may be configured to note the presence of the template 116, for example, by recognizing patterns 118 on the template. For example, the system may recognize an identifying pattern 120 associated with a particular program, such as a drawing application or a computer aided drafting program, among others, or by recognizing patterns associated with individual commands. The pattern recognition may be performed by any number of techniques known in the art, for example, generating a hash code from the pattern, and comparing the hash code to a library of codes. Any number of other techniques may also be used.

The system 100 may respond in a number of ways to recognizing a pattern, for example, the identifying pattern 120 on the template 116. In one embodiment, the system 100 may start a program associated with the identifying pattern 120. The system 100 may analyze the template 116 for other patterns, which can be associated with specific functions, such as save 122, undo 124, redo 126, or fill 128, among many others.

The system 100 can allow gestures to be used for interfacing with programs. For example, an item 130 in a program and shown on the display 106, may be selected by a gesture, such as by using a finger 132 to touch the location of the item 130 on the display 106. Further, a function identified on the template 116 may be selected, for example, by using a finger 132 to touch the relevant pattern 128. Touching the pattern 128 may trigger an operational code sequence associated with the pattern 128, for example, filling a previously selected item 130 with a color. Any number of functions and or shapes may be used in association with a selected item, or with open documents, the operating system itself, and the like, such as printing, saving, deleting, or closing programs, among others. Removing the template 116, or other patterns, from the view of the sensors 102 may trigger actions, such as querying the user about closing the program, saving the document, and the like.

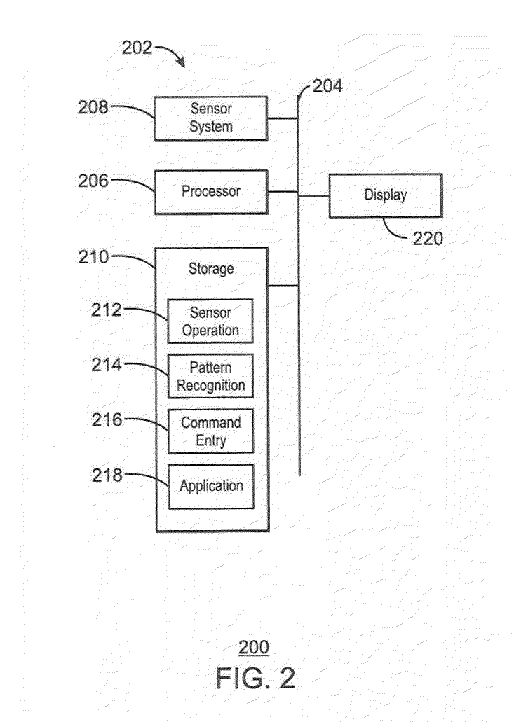

FIG. 2 is a block diagram of a system 200 that may be used to implement an embodiment. The system 200 may be implemented by an all-in-one computer system 202, or may be implemented using a modular computer system. In a modular system, for example, the sensors can be built into a monitor, can be constructed to fit over a top surface of the monitor, or may be free standing sensors placed in proximity to the monitor.

In the all-in-one computer system 202, a bus 204 can provide communications between a processor 206 and a sensor system 208, such as the sensors 102 described with respect to FIG. 1. The bus 204 may be a PCI, PCIe, or any other suitable bus or communications technology. The processor 206 may be a single core processor, a multi-core processor, or a computing cluster. The processor 206 can access a storage system 210 over the bus 204. The storage system 210 may include any combinations of non-transitory, computer readable media, including random access memory (RAM), read only memory (ROM), hard drives, optical drives, RAM drives, and the like. The storage system 210 can hold code and data structures used to implement embodiments of the present techniques, including, for example, a sensor operations module 212 configured to direct the processor 206 to operate the sensor system 208. A pattern recognition module 214 may include code to direct the processor 206 to obtain a pattern from the sensor system 208 and convert the pattern to a mathematical representation that can identify the pattern. The pattern recognition module 214 may also include a data structure that holds a library of patterns, for example, converted into mathematic representations. A command entry module 216 may use the sensor operations module 212 to determine if a command on a template has been selected and pass the appropriate command string on to an application 218.

Other units are generally included in the all-in-one computer system 202 to provide functionality. For example, a human-machine interface may be included to interface to a keyboard or a pointing device. In some embodiments, one or both of the pointing device and keyboard may be omitted in favor of using the functionality provided by the sensor system, for example, using an on-screen keyboard or a keyboard provided, or projected, as a template. A display 220 will generally be built into the all-in-one computer system 202. As shown herein, the display 220 includes driver electronics, coupled to the bus 204, as well as the screen itself. Other units that may be present include a network interface card (NIC) for coupling the all-in-on computer to a network 226. The NIC can include an Ethernet card, a wireless network card, a mobile broadband card, or any combinations thereof.

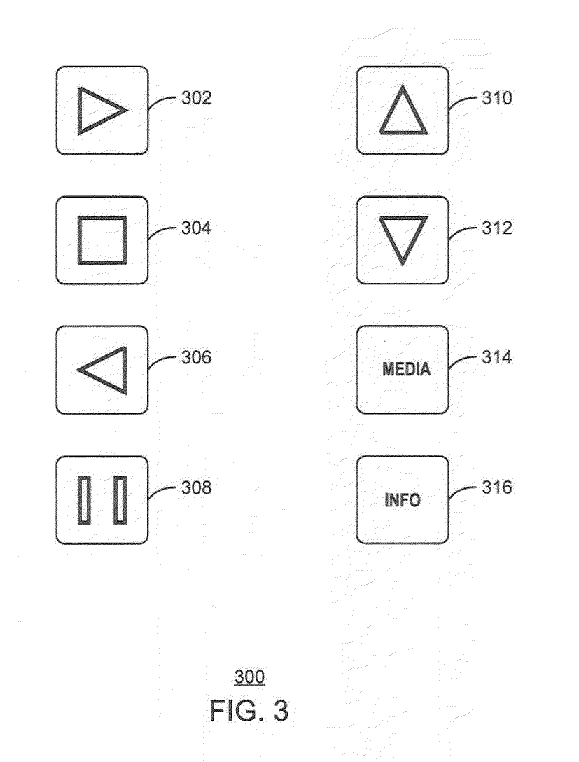

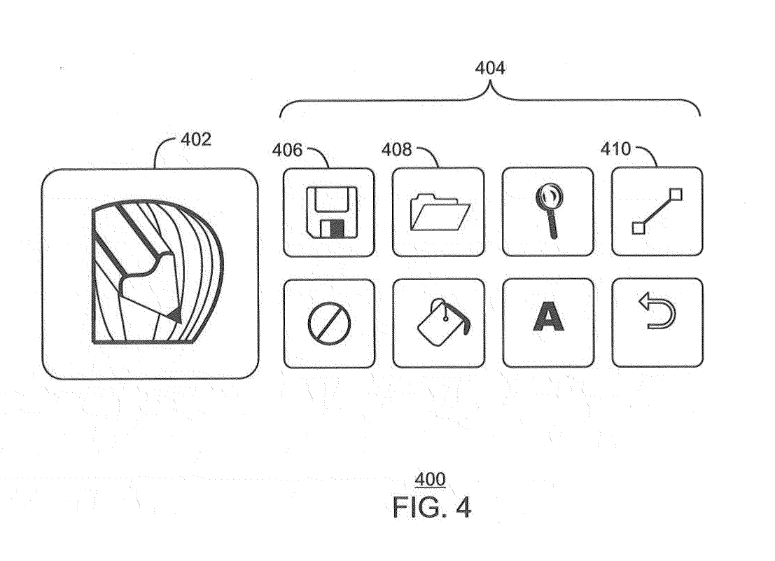

FIG. 3 is a drawing of a command template 300 that can be used to operate programs, in accordance with an embodiment. In this embodiment, no specific pattern identifies a program for use with the template. Instead, the application can be manually started or may be automatically triggered by a pattern recognition of an ensemble of patterns, for example, that may be used to operate a media player, such as WINDOWS MEDIA PLAYER®, REAL PLAYER®, iTUNES®, and the like. The patterns may include buttons for play 302, stop 304, rewind 306, pause 308, volume up 310, and volume down 312, among others. It will be recognized that the controls are not limited to these buttons or this arrangement, as any number of other controls may be used. Such additional controls may include further icons or may include text buttons, such as a button 314 for selecting other media, or a button 316 for getting information on a program. The template 300 may be printed and distributed with a system. Alternatively, the template 300 may be printed out or hand drawn by a user, for example, for a computer system using an infrared sensor, the patterns may be created using an infrared absorbing material such as the toner in a laser printer or a graphite pencil. Templates may also be supplied by software companies with programs as discussed with respect to FIG. 4.

FIG. 4 is an example of a template 400 that may be supplied with a commercial program, in accordance with an embodiment. As discussed previously, the template 400 may have a program pattern 402 that can identify a program. Placing the template 400 in view of the sensors 102 (FIG. 1) may result in automatic activation of the associated program. Alternatively, a user may activate the program manually.

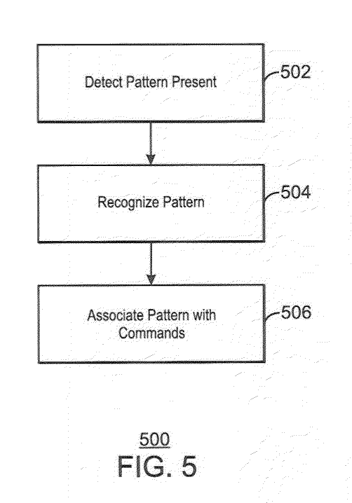

Command patterns 404 on the template 400 may be recognized and associated with commands for the associated program. For example, the command patterns 404 may include commands such as save 406, open 408, line draw 410, and the like. Selecting a command, such as by touching a command pattern 404 on the template, can be used to activate the associated command, for example, generally following the method shown in FIG. 5.

FIG. 5 is a method 500 for entering commands into a system, in accordance with embodiments of the present techniques. The system may be the system discussed with respect to FIGS. 1 and 2. The method 500 begins at block 502 when the systems detects that a template or pattern is present. The detection may be based on identifying a pattern present in view of an imaging sensor. The pattern may be drawn or printed on the template, but is not limited to any particular implementation. Indeed, the pattern may be hand drawn on the desktop in front of the system, so long as the computer can recognize the shape as identifying a program or command.

At block 504, the patterns on the template may be recognized, for example, by comparing a hash code generated from the pattern to a library of codes stored for various patterns. Once a pattern is identified, at block 506, it may be associated with an operational code sequence, such as a command for a program. The program may be manually selected by the user or may be automatically selected by a pattern on the template. Further, equivalent patterns may be associated with different commands depending on the program selected. For example, the play 302 and rewind 306 patterns discussed with respect to FIG. 3 may be associated with channel up and channel down, respectively, in a television tuner application. If a user should select a different program, the patterns may be automatically associated with the correct command, for example, for the program currently selected for display.

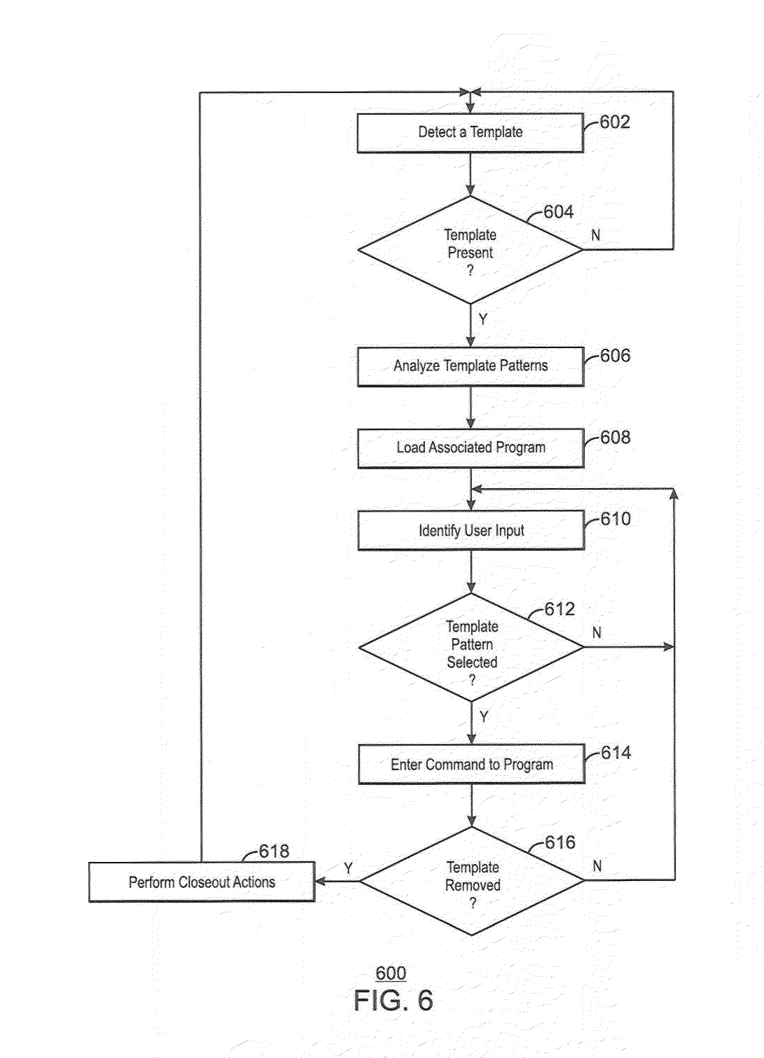

FIG. 6 is a method 600 that may be used to enter commands to a computer system, in accordance with an embodiment. The method 600 begins at block 602 with the computer system detecting a template. The detection may look for all of the patterns present in a library of patterns or may look for patterns that identify specific programs. The latter situation may be used for lowering computational costs on a system when a large number of patterns are present. If a template is recognized as being present at block 604, flow proceeds to block 606, at which the patterns are recognized and associated with relevant commands. At block 608, a program associated with a pattern on the template may be automatically loaded. However, embodiments are not limited to the automatic loading of a program. In some embodiments, a user may manually select a program to be used with the template.

After patterns are associated with commands for a loaded program, at block 610, the computer system may identify an input corresponding to a user action. The input may include the user touching a pattern on a template with a finger or other object. For example, a detection system within the computer system may locate an object in the three dimensional space in front of the screen. When the object and a command location, such as a pattern on the template, intersect, the detection system may send a command to the program through the operating system. In some embodiments, the object may include three dimensional shapes that activate specific commands, or code modules, that are relevant to the shape and the location selected.

An example of such a shape could be a pyramidal object that represents a printer. If the printer shape is touched to a pattern on the template, the associated command may be executed with a parameter controlled by the shape. Such shapes may also represent a program parameter, such as an operational selection. For example, touching a first shape to a pattern on a template may initiate a code module that prints the object, while touching a second shape to a pattern on a template may initiate a code module that saves the current file. Other shapes may activate code modules that modifies the object, or transmits the data representing the object to another system or location.

If a template pattern has been selected at block 612, process flow proceeds to block 614 where an associated command can be entered into the program. At block 616, the system may determine if the template has been removed from the scanned area. If not, process flow may return to block 610 to continue looking for user input. While the computer system is specifically looking for input relevant to the template present, it may detect the placement of another template in view of the imaging sensors, for example, by continuing to execute block 602 in parallel.

If at block 616 it is determined that the template is no longer in the imaged volume in front of the computer system, process flow may proceed to block 618, at which the system may perform a series of actions to close the program. However, embodiments are not limited to automatically closing the program, as the user may manually close the program at any time. In an embodiment, removing the template may have no effect except to eliminate selection of the associated commands using the template. The system may also take other actions to close out the program, such as saving the files in the program or prompting a user to save the files.

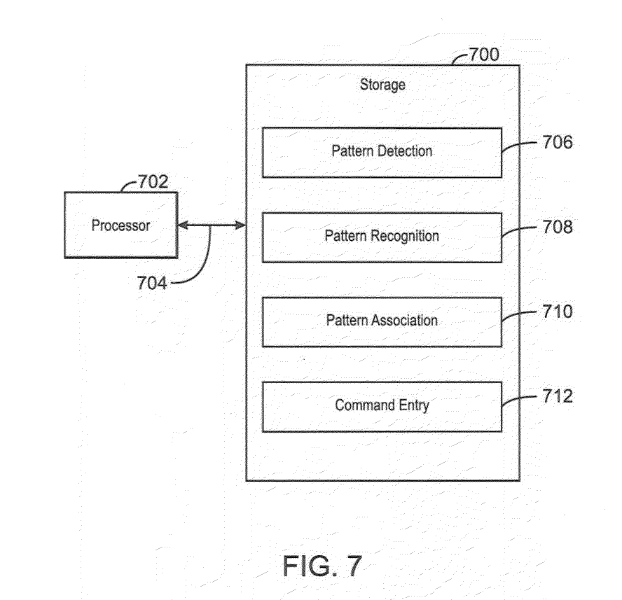

FIG. 7 is a non-transitory computer readable medium 700 that may be used to hold code modules configured to direct a processor 702 to enter commands, in accordance with some embodiments. The processor 702 may include a single core processor, a multi-core processor, or a computing cluster. The processor 702 may access the non-transitory computer readable medium 700 over a bus 704, including, for example, a PCI bus, a PCIe bus, an Ethernet connection, or any number of other communications technologies. The code modules may include a pattern detection module 706, configured to direct a processor to detect a pattern placed in view of a sensor, as described herein. A pattern recognition module 708 may recognize the pattern, and, in some embodiments, start an associated program. A pattern association module 710 may recognize patterns in view of the sensor and associate the patterns with particular operational code sequences, such as commands. A command entry module 712 may detect an intersection of an object, such as a hand or other three dimensional shape, with a pattern, and enter the associated command to a program.

What is claimed is:

1. A method for entering a command into a system, comprising:
detecting a pattern placed in view of a sensor;
recognizing the pattern;
associating the recognized pattern with an operational code sequence; and
executing the operational code sequence, based, at least in part, on an intersection of the recognized pattern and an object detected by the sensor.

2. The method of claim 1, wherein detecting a pattern comprises analyzing an image obtained from the sensor.

3. The method of claim 2, comprising changing a parameter provided to the operational code sequence based, at least in part, on a shape of an object contacting the recognized pattern.

4. The method of claim 3, wherein the parameter may determine an action taken by the operational code sequence.

5. The method of claim 1, comprising activating a program when a pattern associated with the program is detected.

6. The method of claim 1, comprising:
detecting when the recognized pattern is removed from view of the system; and
performing actions to close the program.

7. A command entry system, comprising:
a processor;
a display;
a sensor configured to obtain input from a volume;
a command module configured to direct the processor to:
identify a command based, at least in part, on an image identified in the volume by a pattern recognition module; and
determine if the command has been selected, based, at least in part, on an intersection of the pattern and an object detected by the sensor.

8. The command entry system of claim 7 comprising a template comprising a plurality of patterns.

9. The command entry system of claim 8, wherein an identifying pattern in the plurality of patterns is associated with one of a plurality of applications, and, when the pattern recognition module identifies the identifying pattern, the command module starts the associated one of the plurality of programs.

10. The command entry system of claim 7, comprising an all-in-one computer system.

11. The command entry system of claim 8, wherein the plurality of patterns are printed in an infrared absorbing material.

12. The command entry system of claim 7, wherein the object represents an action that may be taken by a program.

13. The command entry system of claim 7, comprising a stand-alone monitor having an associated sensor.

14. A non-transitory, computer readable medium comprising code configured to direct a processor to:
detect a pattern placed in view of a sensor; recognize the pattern;
associate the recognized pattern with an operational code sequence; and
execute the operational code sequence, based, at least in part, on an intersection of the recognized pattern and an object detected by the sensor.

15. The non-transitory, computer readable medium of claim 14, comprising code configured to direct the processor to analyze images obtained from the sensor.
